(19) United States
(12) Patent Application Publication
(10) Pub. No.: US 2007/0273905 A1
(43) Pub. Date: Nov. 29, 2007

(54) Display apparatus and method for controlling function of the display apparatus

(75) Inventors: Sung-Wen Chang, Taoyuan County (TW); Wei-Hsiang Kao, Taoyuan County (TW); Chih-Kuan Lee, Taoyuan County (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: DELTA ELECTRONICS, INC., Taoyuan County (TW)

(21) Appl. No.: 11/620,605

(22) Filed: Jan. 5, 2007

(30) Foreign Application Priority Data
May 29, 2006 (TW) 095118973

(51) Int. Cl. G06K 15/00

(52) U.S. Cl. 358/1.9; 358/518; 358/1.16

(57) ABSTRACT

A display apparatus and a method for controlling the function of a display apparatus are disclosed. The display apparatus comprises a first memory, a second memory, a color module, and a switch. The first memory stores the first setting data. The second memory stores the second setting data. The color module is installed with one of the first color unit and the second color unit alternatively. The switch chooses either the first memory or the second memory according to the color unit that has been installed in the color module. The display apparatus functions in response to the setting data stored in the chosen memory.

This application claims the benefit of priority based on Taiwan Patent Application No. 095118973 filed on May 29, 2006, the disclosures of which are incorporated by reference in its entirety.

### CROSS-REFERENCES TO RELATED APPLICATIONS

Not applicable.

### BACKGROUND OF THE INVENTION

1. Field of the Invention

The present invention relates to a display apparatus and a method for controlling function of the display apparatus; more specifically, relates to a display apparatus and a method for controlling function of the display apparatus by choosing a setting data stored in different memories.

2. Descriptions of the Related Art

There are currently various types of display apparatuses on the market, such as digital light processing (DLP) projection apparatuses developed by Texas Instruments, Inc. A color wheel in the DLP projection apparatus plays a critical role in displaying color and brightness. When the DLP projection apparatus begins to operate, the color wheel requires initial data, generally stored in the flash read-only memory (Flash ROM). After the DLP projection apparatus is up and running, the parameters for maintaining a normal display of color and brightness are generally stored in the electronically erasable programmable read-only memory (EEPROM).

The use of color wheels vary for displaying appropriate saturation and brightness levels. For example, a DLP projection apparatus used in a conference briefing requires a high level of brightness; therefore, the DLP projection apparatus would use a color wheel with red, green, blue and white sections. The white color section would be used to enhance brightness. Likewise, the DLP projection apparatus used for playing digital cinema requires more delicate color; therefore, the DLP projection apparatus would use two color wheels each having red, green, and blue sections to increase color displaying ability. While these two conventional DLP projection apparatuses utilize two different kinds of color wheels, they both have their own drawbacks. The DLP projection apparatus used in a conference briefing poorly displays delicate color. On the other hand, the DLP projection apparatus used for playing digital cinema has a poor brightness level.

The DLP projection apparatuses developed by Texas Instruments, Inc. are characterized by their ability to use only one color wheel for each application. Therefore, there are currently no single DLP projection apparatuses that can satisfy the high saturation and high brightness levels simultaneously. Users can only choose appropriate DLP apparatuses depending on their particular requirements, thus, forcing them to control for either saturation or brightness level.

In conclusion, a single display apparatus that consists of two color units which store the initial data and parameters needed for a variety of applications is desired in the projector industrial field.

### SUMMARY OF THE INVENTION

One objective of this invention is to provide a display apparatus. The display apparatus comprises a first memory, a second memory, a color module, and a switch. The first memory stores a first setting data. The second memory stores a second setting data. The color module installs one of a first color unit and a second color unit alternatively. The switch chooses one of the first memory and the second memory according to the color unit installed in the color module. As a result, the display apparatus functions in response to the setting data stored in the chosen memory.

Another objective of this invention is to provide a method for controlling function of a display apparatus. The method comprises the following steps: storing a first setting data; storing a second setting data; installing one of a first color unit and a second color unit alternatively in the display apparatus; and choosing one of the first setting data and the second setting data to control the function of the display apparatus according to the installed color unit.

The present invention provides two color units in a display apparatus and a memory for each color unit to store the data that each color unit needs. Specifically, the data consists of, the basic initial data required for the startup of the apparatus, as well as the required parameters for the apparatus to continue functioning. Therefore, users can directly choose the corresponding color unit they need in a single display apparatus under different conditions.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a diagram of a preferable embodiment of a display apparatus of the present invention; and

FIG. 2 is a flow chat of an embodiment of a method for controlling a display apparatus' function of the present invention.

### DESCRIPTION OF THE PREFERRED EMBODIMENT

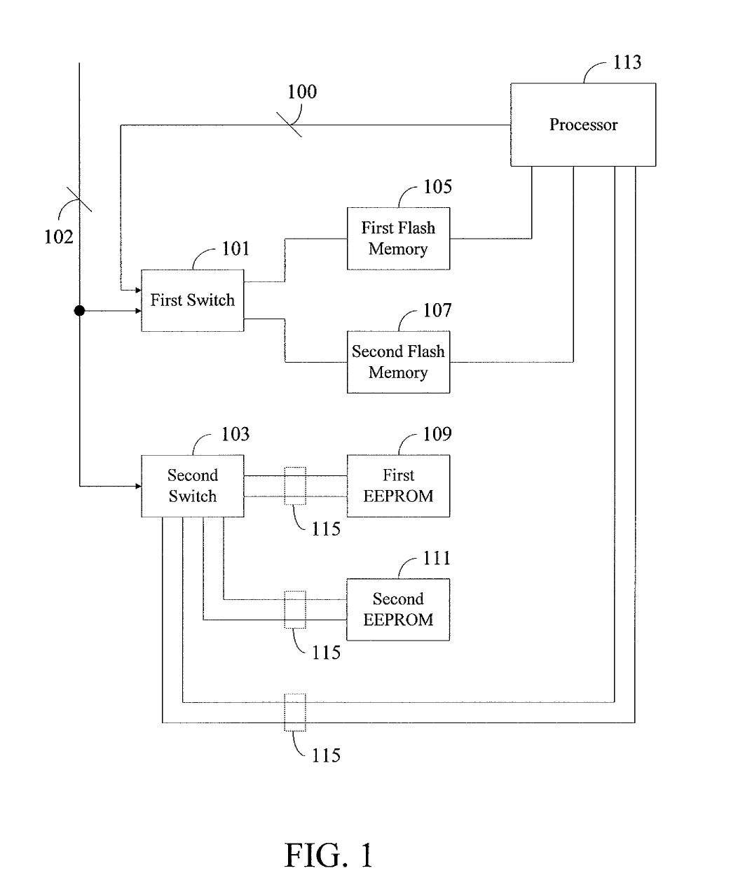

A preferred embodiment of the present invention is a display apparatus as illustrated in FIG. 1. The display apparatus is a DLP projection apparatus, which comprises a color module (not shown), a first switch 101, a second switch 103, a first flash memory 105, a second flash memory 107, a first EEPROM 109, a second EEPROM 111, and a processor 113. The color module can install one of a first color unit and a second color unit alternatively The first color unit or the second color unit is a color wheel of the DLP projection apparatus. The first flash memory 105 stores the first initial data, while the second flash memory 107 stores the second initial data. The first EEPROM 109 stores a first parameter, while the second EEPROM 111 stores a second parameter. The first initial data is essential for the first color unit when the DLP projection apparatus starts to operate, while the first parameter is essential for the first color unit when the projection apparatus functions. Similarly, the second initial data is essential for the second color unit when the DLP projection apparatus starts to operate, while the second parameter is essential for the second color unit when the DLP projection apparatus functions. The first switch 101 is used to choose either the first flash memory 105 or the second flash memory 107 for reading data, while the second switch 103 is used to choose either the first EEPROM 109 or the second EEPROM 111 for reading parameter. Therefore, the processor 113 can read both the initial data and the parameter corresponding to the color unit that is installed in the color module.

The flash memories 105, 107 can be chips of type M25P23 or a series of chips similar to type M25P23 manufactured by STMicroelectronics. The EEPROM 109, 111 can be chips of type M24C08 or a series of chips similar to type M24C08 manufactured by STMicroelectronics. The first switch 101 can be a chip of type ADG779 or a series of chips similar to type ADG779 manufactured by Analog Device, Inc. The second switch 103 can be a chip of type IDT QS3257 or a series of chips similar to type IDT QS3257 manufactured by Integrated Device Technology, Co.

The processor 113 will transmit an enable signal 100 when the DLP projection apparatus starts. The first switch 101 and second switch 103 simultaneously receive a choice signal 102 generated in response to the color unit installed in the color module. The choice signal 102 can be a variable voltage-level signal in the embodiment. When the choice signal 102 is at its first voltage-level, the first color unit is installed in the color module of the DLP projection apparatus. Therefore, the first switch 101 switches to the first flash memory 105, and the second switch 103 switches to the first EEPROM 109 in response to the choice signal 102. The enable signal 100 will enable the first flash memory 105 for the processor 113 to read the first initial data from the first flash memory 105 to start the DLP projection apparatus. After starting, the processor 113 can read the first parameter via the second switch 103 to maintain the function of the first color unit. When the choice signal 102 is at its second voltage-level, the second color unit is installed in the color module of the DLP projection apparatus. Therefore, the first switch 101 switches to the second flash memory 107, while the second switch 103 switches to the second EEPROM 111 in response to the choice signal 102. The enable signal 100 will enable the second flash memory 107 for the processor 113 to read the second initial data from the second flash memory 107 to start the DLP projection apparatus. After starting, the processor 113 can read the second parameter via the second switch 103 to maintain the function of the second color unit. When the processor 113 reads the first parameter stored in the first EEPROM 109 or the second parameter stored in the second EEPROM 111 via the second switch 103, the processor 113, the second switch 103, the first EEPROM 109, and the second EEPROM 111 are connected and transmit the parameters via the inter integrated circuit (I2C) bus 115.

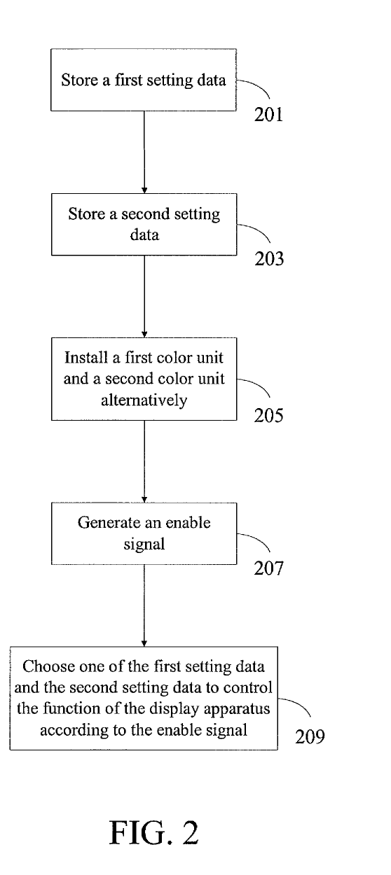

A second embodiment of the present invention is a method for controlling the function of a display apparatus as illustrated in FIG. 2. If the display apparatus is a DLP projection apparatus, the method comprises the following steps. In step 201, the first setting data is stored in the first memory. In step 203, the second setting data is stored in the second memory. In step 205, one of the first color unit and the second color unit are installed alternatively in the DLP projection apparatus. In step 207, the processor of the DLP projection apparatus generates an enable signal. In step 209, either the first setting data or the second setting data is selected to control the function of the DLP projection apparatus according to the enable signal.

When the aforementioned first memory and the second memory are flash memories, the first setting data is the initial data from the first color unit required for starting the DLP projection apparatus. Similarly, the second setting data is the initial data from the second color unit required for starting the DLP projection apparatus. When the aforementioned first and second memory are EEPROMs, the first setting data is a parameter of the first color unit for maintaining the function of the DLP projection apparatus, while the second setting data is a parameter of the second color unit for maintaining the function of the DLP projection apparatus.

The above embodiments only describe an illustration of a DLP projection apparatus that comprises two memories. Furthermore, the display apparatus of the invention can comprise more memories to fit the various requirements and later developments.

Accordingly, the present invention can improve the drawback of the conventional display apparatus where only one color unit can be installed. This present invention can provide two color units in the display apparatus, so that there is an individual memory for each color unit to store initial data and parameters needed for that particular color unit. Thus, the users have the ability to choose the corresponding color unit under different conditions using only one display apparatus.

The above disclosure is related to the detailed technical contents and inventive features thereof. People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

What is claimed is:

1. A display apparatus comprising:
a first memory for storing a first setting data;
a second memory for storing a second setting data;
a color module for installing one of a first color unit and a second color unit alternatively; and
a switch for choosing one of the first memory and the second memory according to the color unit installed in the color module,
wherein the display apparatus functions in response to the setting data stored in the chosen memory.

2. The display apparatus as claimed in claim 1 further comprising a processor for transmitting an enable signal, wherein the switch transmits the enable signal to the chosen memory according to the installed color unit.

3. The display apparatus as claimed in claim 2, wherein the first memory is enabled by the enable signal for the processor reading the first setting data to control the function of the display apparatus when the chosen memory is the first memory, the second memory is enabled by the enable signal for the processor reading the second setting data to control the function of the display apparatus when the chosen memory is the second memory.

4. The display apparatus as claimed in claim 1, wherein the first setting data is an initiate data of the first color unit when the first color unit is installed in the color module, the second setting data is an initiate data of the second color unit when the second color unit is installed in the color module.

5. The display apparatus as claimed in claim 1, wherein the first setting data is a functioning parameter the display apparatus requires when the first color unit is installed in the color module, the second setting data is a functioning parameter the display apparatus requires when the second color unit is installed in the color module.

6. The display apparatus as claimed in claim 5 further comprising an I2C bus, wherein the processor, the switch, the first memory, and the second memory are connected via the I2C bus.

7. The display apparatus as claimed in claim 1, wherein each of the first memory and the second memory is a flash memory.

8. The display apparatus as claimed in claim 1, wherein each of the first memory and the second memory is an erasable programmable read-only memory (EEPROM).

9. The display apparatus as claimed in claim 1, wherein the display apparatus is a digital light processing projection apparatus.

10. A method for controlling function of a display apparatus comprising the steps of:
storing a first setting data;
storing a second setting data;
installing one of a first color unit and a second color unit alternatively in the display apparatus; and
choosing one of the first setting data and the second setting data to control the function of the display apparatus according to the installed color unit.

11. The method as claimed in claim 10 further comprising the steps of:
generating an enable signal according to the installed color unit,
wherein the step of choosing setting data is executed according to the enable signal.

12. The method as claimed in claim 10, wherein the first setting data is an initiate data of the first color unit when the first color unit is installed in the display apparatus, the second setting data is an initiate data of the second color unit when the second color unit is installed in the display apparatus.

13. The method as claimed in claim 10, wherein the first setting data is a functioning parameter the display apparatus requires when the first color unit is installed in the display apparatus, the second setting data is a functioning parameter the display apparatus requires when the second color unit is installed in the display apparatus.

14. The method as claimed in claim 10, wherein the display apparatus is a digital light processing projection apparatus.
